(19) United States
(12) Patent Application Publication
(10) Pub. No.: US 2015/0064548 A1
(43) Pub. Date: Mar. 5, 2015

(54) BATTERY CELL FOR ELECTRONIC DEVICE

(71) Applicant: SAMSUNG SDI CO., LTD., Yongin-si (KR)

(72) Inventor: Sung-Ho HONG, Yongin-si (KR)

(21) Appl. No.: 14/473,260

(22) Filed: Aug. 29, 2014

(30) Foreign Application Priority Data
Sep. 2, 2013 (KR) 10-2013-0104876

(51) Int. Cl. H01M 2/02

(52) U.S. Cl. CPC H01M 2/0207; H01M 2220/30
USPC 429/163

(57) ABSTRACT

A battery cell for an electronic device includes an electrode assembly, an outer case that includes a first outer case and a second outer case that contact each other along edges thereof to form a body portion with a space that accommodates the electrode assembly therein, the edge of the first outer case and the edge of the second outer case together forming a wing portion in at least a portion of the outer circumference of the body portion, and an insulating film that surrounds the wing portion, the insulating film being in a folded state. The insulating film includes an adhesive coated on first and second surfaces on opposite sides of the insulating film from each other, the first surface of the insulating film adhering to the wing portion, and one portion of a second surface adhering to an internal frame of the electronic device.

### CROSS-REFERENCE TO RELATED APPLICATION

Korean Patent Application No. 10-2013-0104876, filed on Sep. 2, 2013, in the Korean Intellectual Property Office, and entitled: “Battery Cell For Electronic Device,” is incorporated by reference herein in its entirety.

### BACKGROUND

1. Field

An aspect relates to a battery cell for an electronic device.

2. Description of the Related Art

Unlike primary batteries that cannot be charged, secondary batteries can be charged/discharged. Secondary batteries are widely used in compact electronic devices such as cellular phones, PDAs, notebook computers, and tablet PCs.

Among various kinds of secondary batteries, a pouch-type secondary battery is manufactured by accommodating an electrode assembly in a pouch outer case and sealing the pouch outer case. The pouch-type secondary battery may have enhanced battery capacity, as compared with a prismatic or cylindrical secondary battery manufactured by accommodating an electrode assembly, using a can made of a metal material.

### SUMMARY

A battery cell for an electronic device including an electrode assembly, an outer case that includes a first outer case and a second outer case that contact each other along an edge of the first outer case and an edge of the second outer case, thereby forming a body portion having a space that accommodates the electrode assembly therein, the edge of the first outer case and the edge of the second outer case together forming a wing portion in at least a portion of an outer circumference of the body portion, and an insulating film that surrounds the wing portion, the insulating film being in a folded state. The insulating film includes an adhesive coated on a first surface and a second surface thereof, the first surface and the second surface of the insulating film being on opposite sides of the insulating film from each other, the first surface of the insulating film adhering to the wing portion, and one portion of a second surface being adherable to an internal frame of the electronic device.

The first surface may include a first portion adhering to the edge of the first outer case forming the wing portion and a second portion adhering to the edge of the second outer case forming the wing portion.

The insulating film may surround the wing portion by extending toward the body portion from an end of the wing portion, the insulating film being folded along a line in a length direction that divides the first portion and the second portion of the first surface from each other.

The one portion of the second surface, being adherable to the internal frame of the electronic device, may be on a directly opposite side of the insulating film from the first portion of the first surface.

The second portion of the first surface may be wider than the first portion of the first surface.

The first surface may further include a third portion that continues from the second portion of the first surface and adheres to a rear surface of the body portion.

Another portion of the second surface may adhere to a side surface of the body portion in a state in which the wing portion is folded toward the body portion.

The one portion of the second surface that is adherable to the internal frame of the electronic device may be on a directly opposite side of the insulating film from the third portion of the first surface.

The another portion of the second surface, adhering to the side surface of the body portion, may be on a directly opposite side of the insulating film from the first portion of the first surface.

The other portion of the second surface may further adhere to a top surface of the body portion.

The other portion of the second surface, adhering to the side and top surfaces of the body portion, may be on a directly opposite side of the insulating film from the first portion of the first surface.

The electrode assembly may include positive and negative electrode tabs that extend to the outside of the outer case.

The electrode assembly may include a positive electrode plate, a negative electrode plate and a separator interposed between the positive and negative electrode plates. The positive electrode tab may be connected to the positive electrode plate, and the negative electrode tab may be connected to the negative electrode plate.

### BRIEF DESCRIPTION OF THE DRAWINGS

Features will become apparent to those of skill in the art by describing in detail exemplary embodiments with reference to the attached drawings in which:

FIG. 1 illustrates a view schematically showing a state in which a general battery cell for an electronic device is installed in the electronic device.

FIG. 2A illustrates a perspective view of a battery cell for an electronic device, viewed from the front side thereof according to an embodiment.

FIG. 2B illustrates a perspective view of the battery cell viewed from the rear side thereof according to the embodiment.

FIG. 3 illustrates an exploded perspective view of the battery cell according to the embodiment.

FIG. 4 illustrates an exploded perspective view of the battery cell according to the embodiment.

FIG. 5 illustrates a sectional view taken along line A-A of FIG. 2.

FIG. 6A illustrates a view showing the insulating film in a state before a wing portion is surrounded with the insulating film according to the embodiment.

FIG. 6B illustrates a sectional view taken along line A-A of FIG. 6A.

FIG. 7A illustrates a view showing the insulating film in a state in which the insulating film surrounds the wing portion according to the embodiment.

FIG. 7B illustrates a sectional view taken along line A-A of FIG. 7A.

FIGS. 8A and 8B illustrate sectional views showing an insulating film according to another embodiment.

FIG. 8C illustrates a sectional view showing an insulating film according to another embodiment.

FIG. 9A illustrates a view schematically showing a state in which the battery cell is installed in an electronic device according to the embodiment.

FIG. 9B illustrates a perspective view showing a state in which the battery cell is installed in an electronic device according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

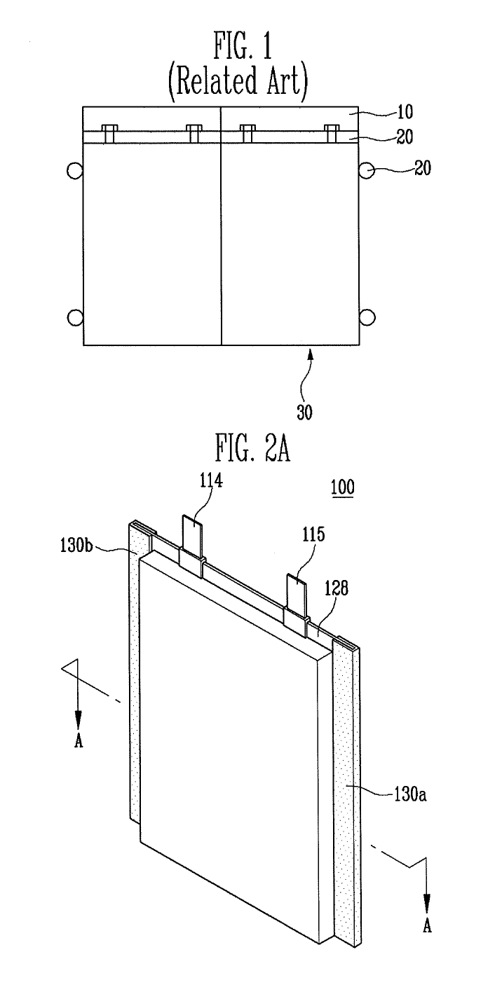

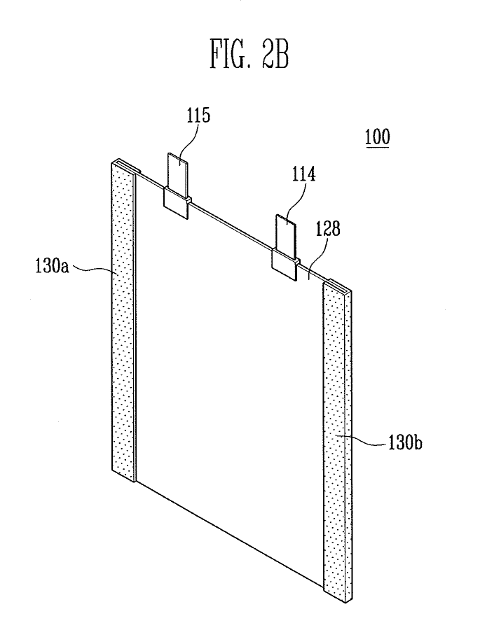

FIG. 2A illustrates a perspective view of a battery cell 100 for an electronic device, viewed from the front side thereof according to an embodiment. FIG. 2B illustrates a perspective view of the battery cell 100 viewed from the rear side thereof according to the embodiment.

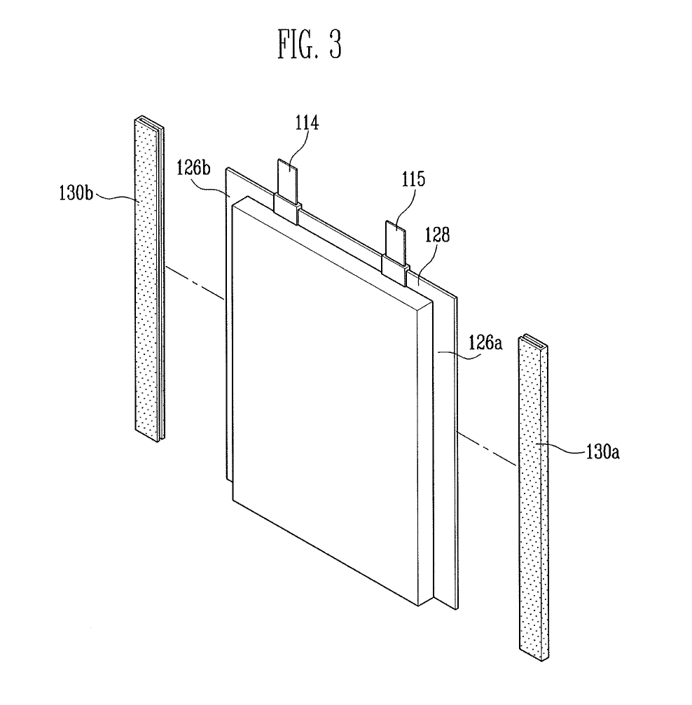

FIGS. 3 and 4 illustrate exploded perspective views of the battery cell 100 according to the embodiment.

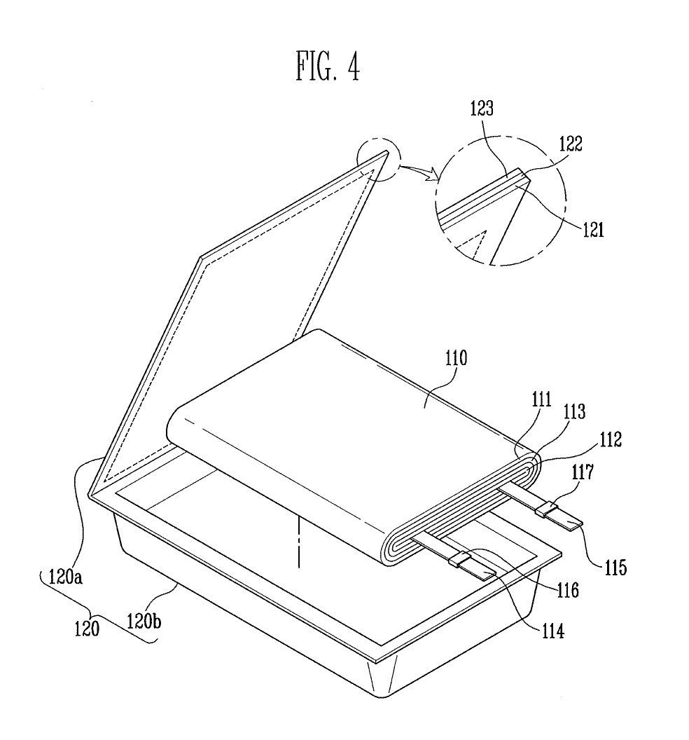

FIG. 5 illustrates a sectional view taken along line A-A of FIG. 2.

As shown in FIGS. 2 to 5, the battery cell 100 includes an electrode assembly 110, an outer case 120, and an insulating film 130.

The electrode assembly 110 may include a positive electrode plate 111, a negative electrode plate 112, and a separator 113 interposed therebetween.

The positive electrode plate 111 may include a positive electrode active material portion formed by coating a positive electrode active material on a surface of a positive electrode collector made of aluminum or the like, and a positive electrode non-coating portion on which the positive electrode active material is not coated. The positive electrode active material may include, for example, a transition metal oxide containing lithium, such as LiCoO₂, LiNiO₂, LiMnO₂, or LiMnO₄, or a lithium chalcogenide compound. A positive electrode tab 114 having a predetermined length may be bonded to the positive electrode non-coating portion.

The negative electrode plate 112 may include a negative electrode active material portion formed by coating a negative electrode active material on a surface of a negative electrode collector made of nickel or the like, and a negative electrode non-coating portion on which the negative electrode active material is not coated. The negative electrode active material may include, for example, a carbon material such as crystalline carbon, amorphous carbon, carbon complex or carbon fiber, a lithium metal, a lithium alloy, etc. A negative electrode tab 115 having a predetermined length may be bonded to the negative electrode non-coating portion.

The electrode assembly 110 may be manufactured by forming a stacked structure in which the separator 113 is interposed between the positive and negative electrode plates 111 and 112 and then winding the stacked structure.

The electrode assembly 110 may be electrically connected to the outside through the positive and negative electrode tabs 114 and 115. The positive electrode tab 114 may be electrically connected to the positive electrode plate 111, and the negative electrode tab 115 may be electrically connected to the negative electrode plate 112.

The positive and negative electrode tabs 114 and 115 may be provided with insulating tapes 116 and 117 for insulating the positive and negative electrode tabs 114 and 115 from upper and lower outer case 120a and 120b, respectively.

The outer case 120 according to this embodiment accommodates the electrode assembly 110 therein, and includes the upper and lower outer case 120a and 120b.

The upper and lower outer cases 120a and 120b may contact each other along edges thereof, thereby forming a body portion 124 provided with a space in which the electrode assembly 110 is accommodated. A wing portion 126 may be formed at one or more portions of the outer circumference of the body portion 124.

According to this embodiment, the upper and lower outer cases 120a and 120b may form the body portion 124 when the upper and lower outer cases 120a and 120b are integrally bonded to each other along the edges thereof, thereby hermetically sealing the electrode assembly 110.

The space for accommodating the electrode assembly 110 therein may be formed in the lower outer case 120b by a press machining method.

As illustrated in FIG. 4, the space for accommodating the electrode assembly 110 therein may be formed in the lower outer case 120b, and the upper and lower outer cases 120a and 120b may be integrally bonded along the edges thereof, thereby forming the body portion 124. In other implementations, the body portion may be formed such that the space for accommodating the electrode assembly 110 therein is formed in each of the upper and lower outer cases, and the upper and lower outer cases may be integrally bonded along the edges thereof.

The outer case 120 may have a stacked structure in order to serve as a pouch for the battery cell. For example, the outer case 120 may have a multi-layered structure including a thermal fusion layer 121 having a thermal fusion property to act as a sealing material, a metal layer 122 including a metal material to act as a barrier of moisture and oxygen while maintaining a mechanical strength, and an insulating layer 123.

In the stacked structure, the thermal fusion layer 121 may be formed on one surface of the metal layer 122, and the insulating layer 123 may be formed on the other surface of the metal layer 122.

The metal layer 122 may include a material such as aluminum, steel, or stainless steel. The thermal fusion layer 121 may include an olefin-based resin material such as modified polypropylene. The insulating layer 123 may include a material such as polyethyleneterephthalate (PET) or nylon.

After the electrode assembly 110 is accommodated in the accommodating space of the lower outer case 120b, the edges of the upper and lower outer cases 120a and 120b may be bonded using a method such as thermal fusion.

The positive and negative electrode tabs 114 and 115 may be extracted through a terrace portion 128, which may be any one of the bonding surfaces of the upper and lower outer cases 120a and 120b. First and second wing portions 126a and 126b may be respectively provided at both sides vertical to the terrace portion 128.

The first and second wing portions 126a and 126b, as described below, may be bent to surround a side surface of the body portion 124.

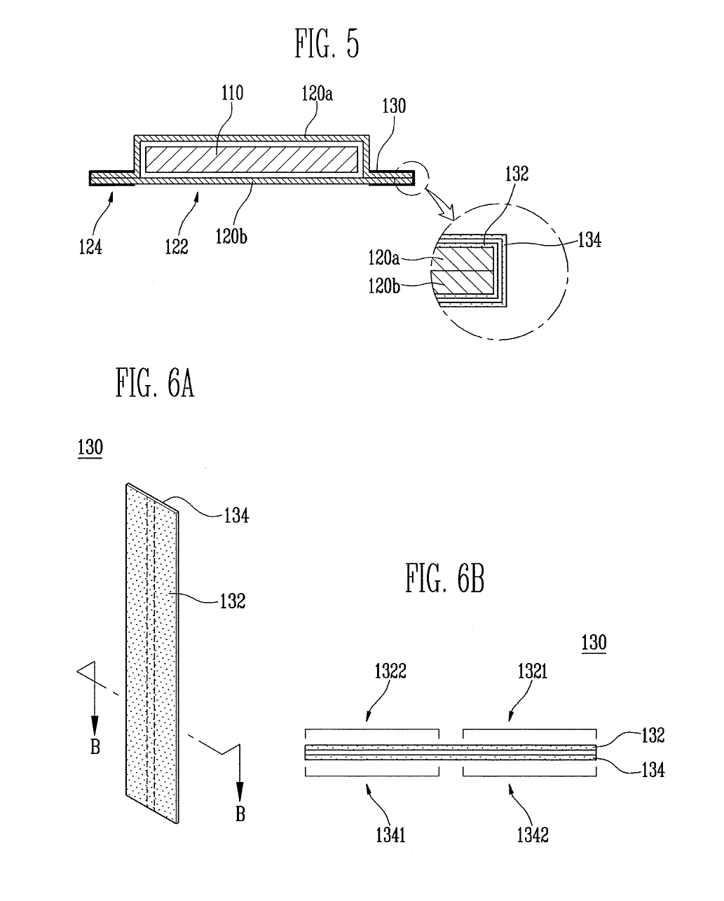

Referring to enlarged views illustrated in FIGS. 5 and 6, each of the first and second wing portions 126a and 126b may be in a state in which the upper and lower outer cases 120a and 120b overlap with each other. The metal layer 122 may be exposed at the end portions of the first and second wing portions 126a and 126b. Accordingly, if the insulating film 130, as described below, were not present, and if an electrolyte were to leak as the battery cell is used for a long period of time, a short circuit could occur through the metal layer 122. Therefore, it is desirable to insulate the metal layer 122.

More specifically, the insulating film 130 may surround the wing portion 126 in such a manner that a first surface 132 of the insulating film 130 adheres to the wing portion 126. The insulating film 130 may include an adhesive that is coated on both a first surface 132 and a second surface 134, located on opposite sides of the insulating film. The insulating film 130 may be folded along the length direction thereof. One portion of a second surface 134 positioned at the opposite side of the first surface 132 may adhere to an internal frame of the electronic device 10.

The insulating film 130 may insulate the wing portion 126, and simultaneously may enable the battery cell 100 to be attached to the inside of the electronic device 10 without any separate fixing member or adhesive.

The battery cell 100 may include two insulating films 130a and 130b that surround the respective first and second wing portions 126a and 126b. Herein, the configuration of one of the insulating films will be mainly described for convenience of illustration, and it is to be understood that the same description may be applied to the other insulating film.

Herein, it is assumed that, for convenience of illustration, the electrode device 10 having the battery cell 100 installed therein is a tablet PC.

Hereinafter, the configuration of the insulating film 130 according to the embodiment will be described in detail with reference to FIGS. 6 to 9.

FIG. 6A illustrates a view showing the insulating film 130 a state before the wing portion 126 is surrounded with the insulating film 130 according to the embodiment. FIG. 6B illustrates a sectional view taken along line A-A of FIG. 6A.

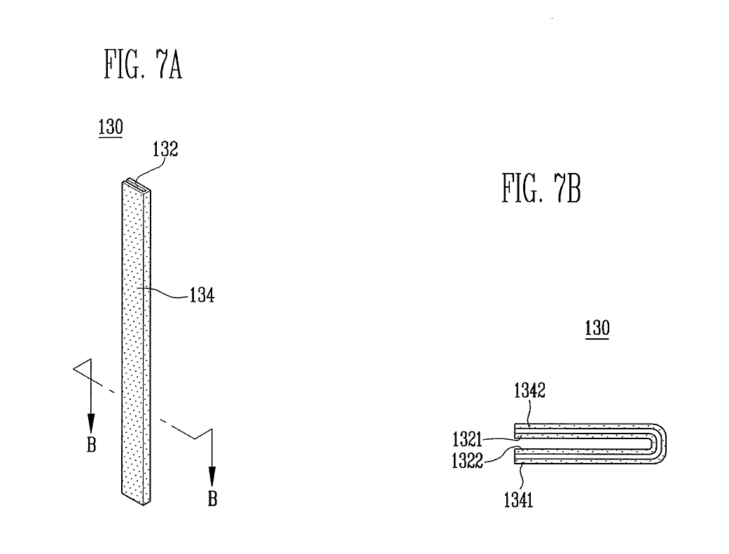

FIG. 7A illustrates a view showing the insulating film 130 in a state in which the wing portion 126 is surrounded with the insulating film 130 according to the embodiment. FIG. 7B illustrates a sectional view taken along line A-A of FIG. 7A.

As shown in FIGS. 6 and 7, the first surface 132 of the insulating film 130 may include a first portion 1321 that adheres to an edge of the upper outer case 120a forming the wing portion 126, and a second portion 1322 that to an edge of the lower outer case 120b forming the wing portion 126.

The insulating film 130 may surround the wing portion 126 by extending inwardly from an end of the wing portion 126. The insulating film 130 may be folded along the line in the length direction that divides the first portion 1321 and the second portion 1322 from each other.

One portion 1341 of the second surface 134 positioned at the opposite side of the first surface 132 of the insulating film 130 may adhere to the internal frame of the electronic device.

The one portion 1341 of the second surface 134 may be located at a position corresponding to the second portion 1322 of the first surface 132. Herein, the terms “corresponds” or “corresponding,” when referring to specific portions of the insulating film 130 indicate that the specific portions are located at the same position of the insulating film 130 at opposite sides of the insulating film 130 from each other. For example, the one portion 1341 of the second surface 134 and the second portion 1322 of the first surface 132 may be located at the same position on opposite surfaces of the insulating film 130.

The second portion 1322, adhering to the edge of the lower outer case 120b, may be wider than the first portion 1321, adhering to the edge of the upper outer case 120a. Accordingly, the one portion 1341 of the second surface 134, located at a position corresponding to the second portion 1322 of the first surface 132, may be relatively wide. The adhesion area between the one portion 1341 of the second surface 134 and the internal frame of the electronic device 10 may be increased. Accordingly, the battery cell 100 may be more stably attached to the inside of the electronic device 10.

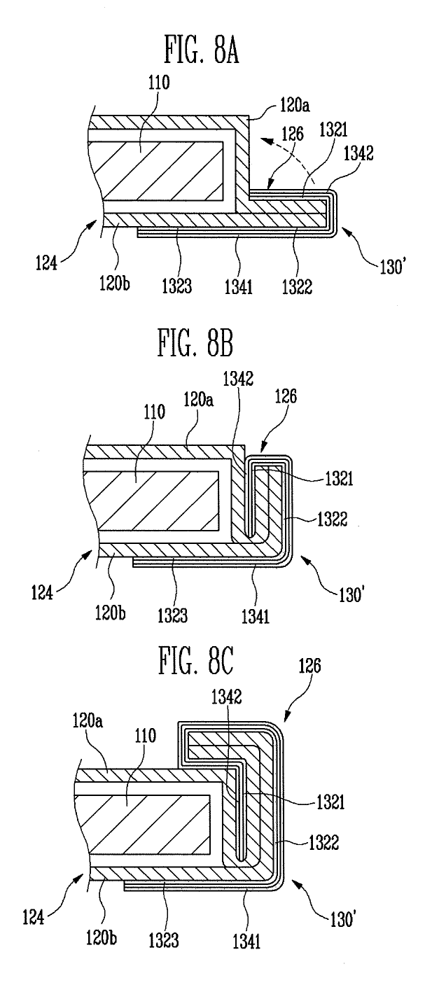

FIGS. 8A and 8B illustrate sectional views showing an insulating film 130′ according to another embodiment.

As shown in FIG. 8, the first surface 132 of the insulating film 130′ according to this embodiment may further include, in addition to the configuration shown in FIGS. 6 and 7, a third portion 1323 that continues from the second portion 1322 and adheres to a rear surface of the body portion 124.

Such a structure may allow the adhesion area between the insulating film 130′ and the outer case 120 to be wider, such that it may be possible to stably insulate the wing portion 126 and to increase the adhesion area between the insulating film 130′ and the internal frame of the electronic device 10. Accordingly, the battery cell 100 may be more firmly attached to the inside of the electronic device 10.

In a case where the insulating film 130′ further includes the third portion 1323 as shown in FIG. 8B, the other portion 1342 of the second surface 134 of the insulating film may adhere to the side surface of the body portion 124 in a state in which the wing portion 126 is folded toward the body portion 124.

The other portion 1342 of the second surface 134 of the insulating film 130′ may be located at a position corresponding to the first portion 1321 of the first surface 132 of the insulating film 130′. The other portion 1342 of the second surface and the first portion 1321 of the first surface 132 may be located at the same position on opposite sides of the insulating film 130′. The one portion 1341 of the second surface 134 adhered to the internal frame of the electronic device 10 may be located at a position corresponding to the third portion 1323. The one portion 1341 of the second surface 134 and the third portion 1323 of the first surface 132 may be located at the same position on opposite surfaces of the insulating film 130′.

FIGS. 8C illustrates a sectional view showing an insulating film 130′ according to another embodiment. As shown in FIG. 8C, the other portion 1342 of the second surface 132 of the insulating film 130′ may further adhere to not only the side surface of the body portion 124 but also may adhere to a front area of the body portion 124.

The other portion 1342 of the second surface 134 of the insulating film 130′ may be formed sufficiently longer than the height of the body portion 124, so as to be adhere to the side surface and the front area of the body portion 124 in the state in which the wing portion 126 is folded toward the body portion 124.

As the adhesion area is increased, the wing portion 126 may be stably attached to the body portion 124, thereby increasing the reliability of insulation for the insulating film.

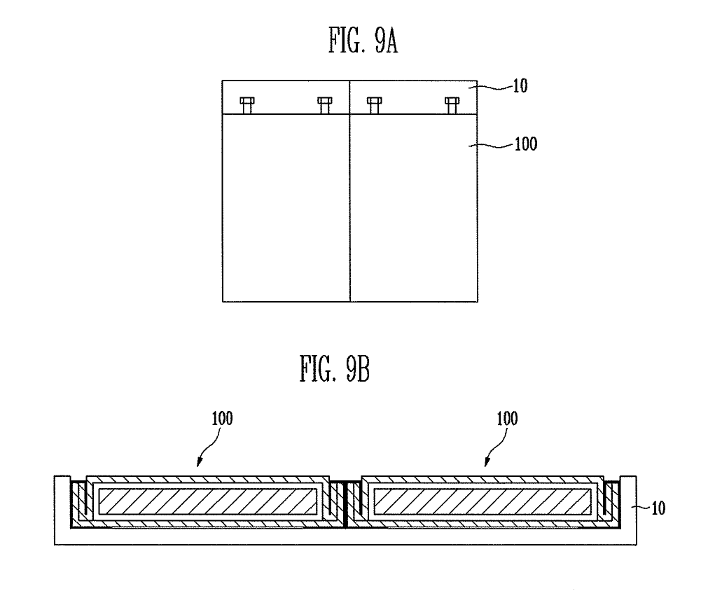

FIGS. 9A and 9B illustrate a state in which the battery cell 100 is installed in an electronic device 10 according to the embodiment. As shown in FIGS. 9A and 9B, the battery cell 100 may be directly installed in an electronic device 10 such as a tablet PC without any separate fixing member.

By way of summation and review, a general pouch-type secondary battery may be installed in the electronic device using a separate fixing member 20, as illustrated in FIG. 1 or using a separate adhesive. However, using the separate fixing member or adhesive increases the number of processes in the manufacturing of the electronic device, which is disadvantageous in terms of increasing unit costs. In a case where the adhesive is used, a quality risk may be increased due to the occurrence of attachment distribution caused by a change in the size of a battery cell.

Embodiments provide a battery cell 100 that may be directly installed in an electronic device through the insulating film 130 for insulating the wing portion 126 without any separate fixing member or adhesive. Accordingly, it may be possible to reduce the manufacturing cost of the battery cell by decreasing the number of working processes when the battery cell is installed in the electronic device. Further, the battery cell may be stably installed in the electronic device even in the event that the size of the battery cell is changed.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A battery cell for an electronic device, the battery cell comprising:
an electrode assembly;
an outer case that includes a first outer case and a second outer case that contact each other along an edge of the first outer case and an edge of the second outer case, thereby forming a body portion having a space that accommodates the electrode assembly therein, the edge of the first outer case and the edge of the second outer case together forming a wing portion in at least a portion of sn outer circumference of the body portion; and
an insulating film that surrounds the wing portion, the insulating film being in a folded state,
wherein the insulating film includes an adhesive coated on a first surface and a second surface thereof, the first surface and the second surface of the insulating film being on opposite sides of the insulating film from each other, the first surface of the insulating film adhering to the wing portion, and one portion of a second surface being adherable to an internal frame of the electronic device.

2. The battery cell as claimed in claim 1, wherein the first surface includes:
a first portion adhering to the edge of the first outer case forming the wing portion; and
a second portion adhering to the edge of the second outer case forming the wing portion.

3. The battery cell as claimed in claim 2, wherein the insulating film surrounds the wing portion by extending toward the body portion from an end of the wing portion, the insulating film being folded along a line in a length direction that divides the first portion and the second portion of the first surface from each other.

4. The battery cell as claimed in claim 3, wherein the one portion of the second surface, being adherable to the internal frame of the electronic device, may be on a directly opposite side of the insulating film from the second portion of the first surface.

5. The battery cell as claimed in claim 4, wherein the second portion of the first surface is wider than the first portion of the first surface.

6. The battery cell as claimed in claim 3, wherein the first surface further includes a third portion that continues from the second portion of the first surface and adheres to a rear surface of the body portion.

7. The battery cell as claimed in claim 6, wherein another portion of the second surface adheres to a side surface of the body portion in a state in which the wing portion is folded toward the body portion.

8. The battery cell as claimed in claim 7, wherein the one portion of the second surface that is adherable to the internal frame of the electronic device is on a directly opposite side of the insulating film from the third portion of the first surface.

9. The battery cell as claimed in claim 8, wherein the another portion of the second surface, adhering to the side surface of the body portion, is on a directly opposite side of the insulating film from the first portion of the first surface.

10. The battery cell as claimed in claim 8, wherein the another portion of the second surface further adheres to a top surface of the body portion.

11. The battery cell as claimed in claim 10, wherein the another portion of the second surface, adhering to the side and top surfaces of the body portion, may be on a directly opposite side of the insulating film from the first portion of the first surface.

12. The battery cell as claimed in claim 1, wherein the electrode assembly includes positive and negative electrode tabs that extend to the outside of the outer case.

13. The battery cell as claimed in claim 12, wherein:
the electrode assembly includes a positive electrode plate, a negative electrode plate and a separator interposed between the positive and negative electrode plates, and
the positive electrode tab is connected to the positive electrode plate, and the negative electrode tab is connected to the negative electrode plate.
